(19) United States
(12) Patent Application Publication
(10) Pub. No.: US 2005/0071380 A1
(43) Pub. Date: Mar. 31, 2005

(54) Apparatus and method to coordinate multiple data storage and retrieval systems

(76) Inventors: William F. Micka, Tucson, AZ (US); Gail A. Spear, Tucson, AZ (US); Warren K. Stanley, Tucson, AZ (US); Aviad Zlotnick, Mitzpeh Netofah (IL)

Correspondence Address: LAW OFFICE OF DALE F. REGELMAN, P.C., 4231 S. Fremont Avenue, Tucson, AZ, 85714, US

(21) Appl. No.: 10/675,289

(22) Filed: Sep. 29, 2003

(51) Int. Cl. G06F 12/00

(52) U.S. Cl. 707/200

(57) ABSTRACT

A method to coordinate interconnected information storage and retrieval systems, where each of the information and storage systems is capable of communicating with one or more host computers. The method provides a plurality of controllers and one or more information storage and retrieval systems, where each of the plurality of controllers is disposed in one of the one or more information storage and retrieval systems. The method designates one of the plurality of controllers as a master controller and the remaining controllers as target controllers. The method then generates one or more master controller commands by the master controller, and provides those one or more master controller commands to each of said target controllers, where the one or more master controller commands cause said target controllers to adjust the flow of data into and out of the one or more information storage and retrieval systems.

### FIELD OF THE INVENTION

This invention relates to an apparatus and method to coordinate multiple data storage and retrieval systems. In certain embodiments, the invention relates to an apparatus and method to ensure sequential data consistency in multiple data storage and retrieval systems.

### BACKGROUND OF THE INVENTION

Many data processing systems require a large amount of data storage, for use in efficiently accessing, modifying, and re-storing data. Data storage is typically separated into several different levels, each level exhibiting a different data access time or data storage cost. A first, or highest level of data storage involves electronic memory, usually dynamic or static random access memory (DRAM or SRAM). Electronic memories take the form of semiconductor integrated circuits where millions of bytes of data can be stored on each circuit, with access to such bytes of data measured in nanoseconds. The electronic memory provides the fastest access to data since access is entirely electronic.

A second level of data storage usually involves direct access storage devices (DASD). DASD storage, for example, includes magnetic and/or optical disks. Data bits are stored as micrometer-sized or less magnetically or optically altered spots on a disk surface, representing the “ones” and “zeros” that comprise the binary value of the data bits. Magnetic DASD includes one or more disks that are coated with remnant magnetic material. DASDs can store gigabytes of data, and the access to such data is typically measured in milliseconds, i.e. orders of magnitudes slower than electronic memory.

Having a backup data copy is mandatory for many businesses for which data loss would be catastrophic. The time required to recover lost data is also an important recovery consideration. With tape or library backup, primary data is periodically backed-up by making a copy on tape or library storage at a remote storage location.

Data disaster recovery solutions include peer-to-peer copy where data is backed-up not only remotely, but also continuously, either synchronously or asynchronously. Using such a peer-to-peer network, the secondary data must be “order consistent,” that is, secondary data is copied in the same sequential order as the primary data, i.e. sequential consistency. Without sequential consistency, inconsistent secondary data would result, thus corrupting disaster recovery.

What is needed is a method to coordinate multiple data storage and retrieval systems. More particularly, what is needed is a method to ensure the sequential consistency of data stored in those multiple data storage and retrieval systems.

### SUMMARY OF THE INVENTION

Applicants' invention includes a method to coordinate interconnected information storage and retrieval systems, where each of the information and storage systems is capable of communicating with one or more host computers. Applicants' method provides a plurality of controllers, where at least one of those plurality of controllers is disposed in each of the information storage and retrieval systems.

Applicants' method designates one of the plurality of controllers as a master controller and the remaining controllers as target controllers, generates one or more master controller commands by that master controller, and provides those one or more master controller commands to each of the target controllers, where the one or more master controller commands cause each of those target controllers to adjust the flow of data into and out of each of the information storage and retrieval systems.

### BRIEF DESCRIPTION OF THE DRAWINGS

The invention will be better understood from a reading of the following detailed description taken in conjunction with the drawings in which like reference designators are used to designate like elements, and in which:

FIG. 1 is a block diagram showing the components of Applicants' data storage and retrieval system;

FIG. 2 is a flow chart summarizing the steps in Applicants' method;

FIG. 3 is a block diagram showing three interconnected data storage and retrieval system and a host computer;

FIG. 4 is a block diagram showing the three data storage and retrieval systems and host computer of FIG. 3 interconnected to three remote storage locations;

### DETAILED DESCRIPTION OF THE PREFERRED EMBODIMENTS

Referring to the illustrations, like numerals correspond to like parts depicted in the Figures. The invention will be described as embodied in a system comprising multiple information storage and retrieval systems. In certain embodiments, one or more of Applicants' information storage and retrieval systems comprises two or more subsystems sometimes referred to as “clusters.” In certain embodiments, one or more of Applicants' information and storage retrieval systems do not include individual clusters.

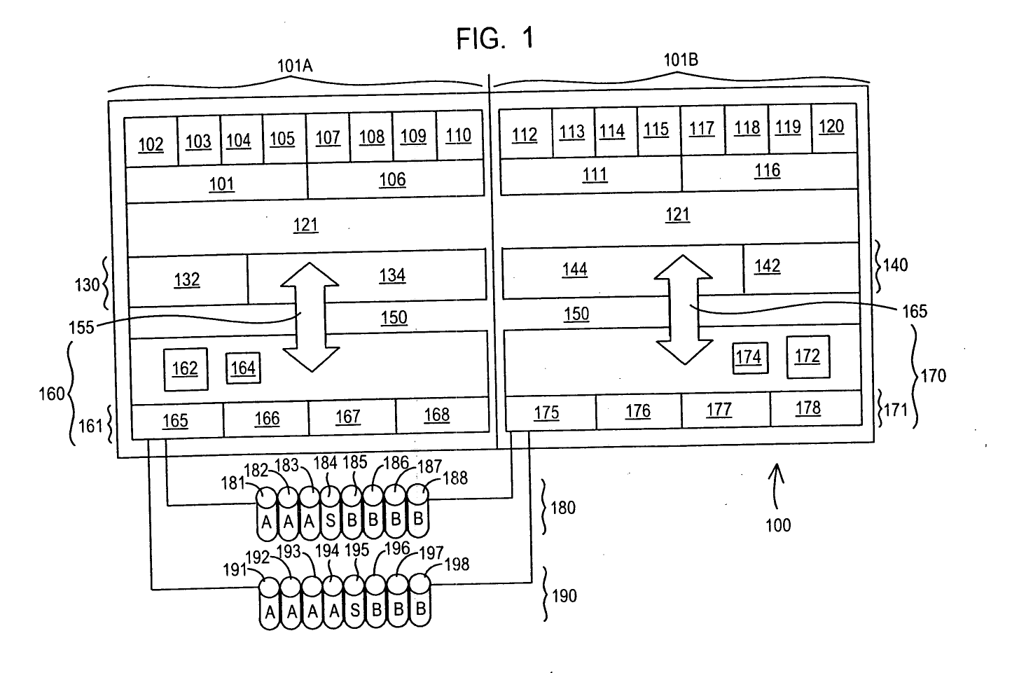

Referring now to FIG. 1, Applicants' information storage and retrieval system 100 includes a first subsystem 101A and a second subsystem 101B. Each subsystem includes a processor portion 130/140 and an input/output portion 160/170. Internal PCI buses in each subsystem are connected via a Remote I/O bridge 155/165 between the processor portions 130/140 and I/O portions 160/170, respectively.

Information storage and retrieval system 100 further includes a plurality of input/output (“I/O”) adapters 102-105, 107-110, 112-115, and 117-120, disposed in four bays 101, 106, 111, and 116. Each I/O adapter may comprise one Fibre Channel port, one FICON port, two ESCON ports, or two SCSI ports. Each I/O adapter is connected to both subsystems through one or more Common Platform Interconnect buses 121 and 150 such that each subsystem can handle I/O from any I/O adapter.

Processor portion 130 includes processor 132 and cache 134. In certain embodiments, processor 132 comprises a 64-bit RISC based symmetric multiprocessor. In certain embodiments, processor 132 includes built-in fault and error-correction functions. Cache 134 is used to store both read and write data to improve performance to the attached host systems. In certain embodiments, cache 134 comprises about 4 gigabytes. In certain embodiments, cache 134 comprises about 8 gigabytes. In certain embodiments, cache 134 comprises about 12 gigabytes. In certain embodiments, cache 144 comprises about 16 gigabytes. In certain embodiments, cache 134 comprises about 32 gigabytes.

Processor portion 140 includes processor 142 and cache 144. In certain embodiments, processor 142 comprises a 64-bit RISC based symmetric multiprocessor. In certain embodiments, processor 142 includes built-in fault and error-correction functions. Cache 144 is used to store both read and write data to improve performance to the attached host systems. In certain embodiments, cache 144 comprises about 4 gigabytes. In certain embodiments, cache 144 comprises about 8 gigabytes. In certain embodiments, cache 144 comprises about 12 gigabytes. In certain embodiments, cache 144 comprises about 16 gigabytes. In certain embodiments, cache 144 comprises about 32 gigabytes.

I/O portion 160 includes non-volatile storage (“NVS”) 162 and NVS batteries 164. NVS 162 is used to store a second copy of write data to ensure data integrity should there be a power failure of a subsystem failure and the cache copy of that data is lost. NVS 162 stores write data provided to subsystem 101B. In certain embodiments, NVS 162 comprises about 1 gigabyte of storage. In certain embodiments, NVS 162 comprises four separate memory cards. In certain embodiments, each pair of NVS cards has a battery-powered charging system that protects data even if power is lost on the entire system for up to 72 hours.

I/O portion 170 includes NVS 172 and NVS batteries 174. NVS 172 stores write data provided to subsystem 101A. In certain embodiments, NVS 172 comprises about 1 gigabyte of storage. In certain embodiments, NVS 172 comprises four separate memory cards. In certain embodiments, each pair of NVS cards has a battery-powered charging system that protects data even if power is lost on the entire system for up to 72 hours.

In the event of a failure of subsystem 101B, the write data for the failed subsystem will reside in the NVS 162 disposed in the surviving subsystem 101A. This rite data is then destaged at high priority to the hard disk arrays. At the same time, the surviving subsystem 101A will begin using NVS 162 for its own write data thereby ensuring that two copies of write data are still maintained.

I/O portion 160 further comprises a plurality of device adapters, such as device adapters 165, 166, 167, and 168, and sixteen disk drives organized into two arrays, namely array “A” and array “B”. In certain embodiments, arrays “A” and “B” utilize a RAID protocol. In certain embodiments, arrays “A” and “B” comprise what is sometimes called a JBOD array, i.e. “Just a Bunch Of Disks” where the array is not configured according to RAID. The illustrated embodiment of FIG. 1 shows two hard disk arrays. In other embodiments, Applicants' information storage at retrieval system includes more than two hard disk arrays.

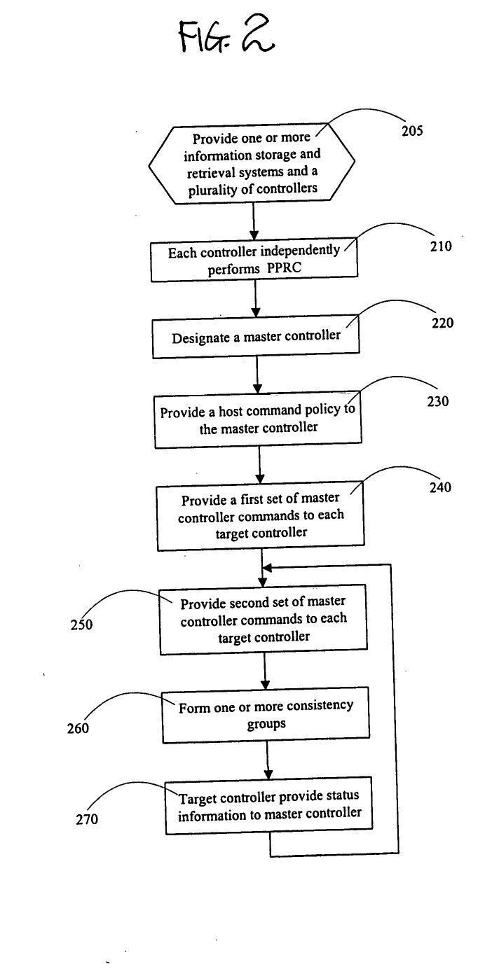

Applicants' invention includes a method to coordinate multiple information storage and retrieval systems. FIG. 2 summarizes the steps in Applicants' method. Referring now to FIG. 2, in step 205 Applicants' method provides a plurality of controllers and one or more interconnected information storage and retrieval systems, wherein each of those information storage and retrieval systems includes one or more controllers.

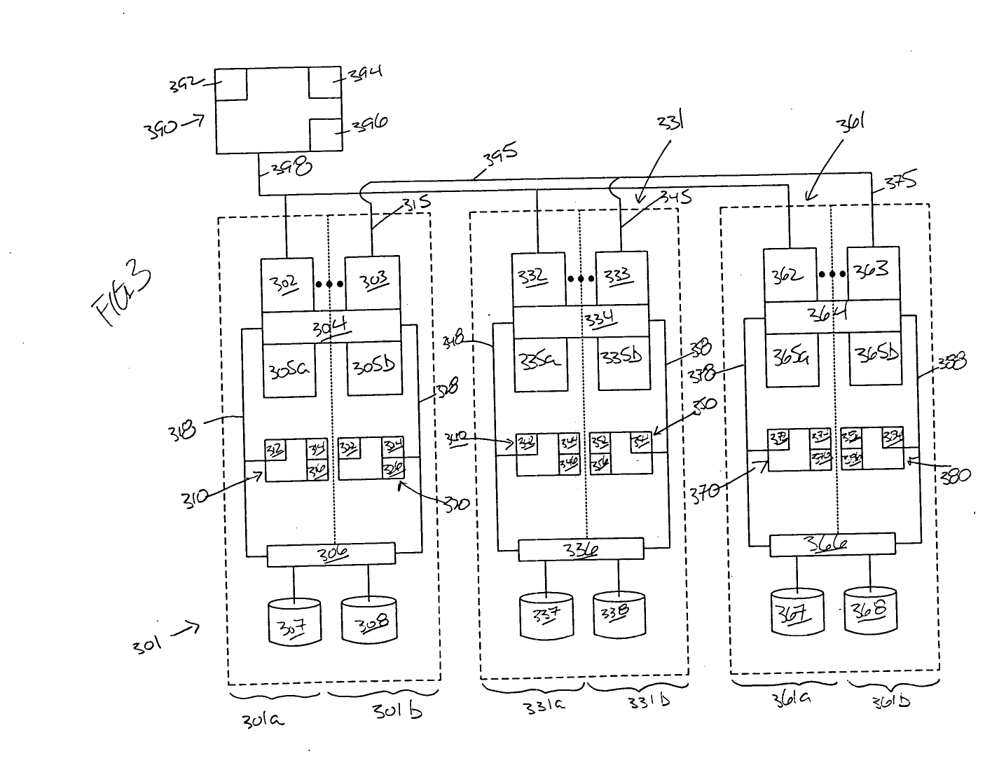

For example, the illustrated embodiment of FIG. 3 includes three (3) information storage and retrieval systems, namely systems 301, 331, and 361. Information storage and retrieval systems 301, 331, and 361, each comprise one or more I/O adapters, such as I/O adapters 302/303, I/O adapters 332/333, and I/O adapters 362/363, respectively. In the illustrated embodiment of FIG. 3, information storage and retrieval systems 301, 331, and 361, each include two subsystems, namely 301a/301b, 331a/331b, and 361a/361b, respectively. Subsystems 301a and 301b communicate with hard disk arrays 307 and 308 via device adapter 306. Subsystems 331a and 331b communicate with hard disk arrays 337 and 338 via device adapter 336. Subsystems 361a and 361b communicate with hard disk arrays 367 and 368 via device adapter 366.

References herein to “subsystems” should not be interpreted to mean that either Applicants' apparatus or method is limited to information storage and retrieval systems comprising two subsystems. In certain embodiments, one or more of Applicants' information storage and retrieval systems include a single system. In certain embodiments, one or more of Applicants' information storage and retrieval systems include two subsystems. In certain embodiments, one or more of Applicants' information storage and retrieval systems include more than two subsystems.

Each system/subsystem includes an information cache, such as cache 305a, 305b, 335a, 335b, 365a, and 365b. Each system/subsystem includes at least one controller, such as controller, 310, 320, 340, 350, 370, and 380. Each controller includes logic, such as logic 312, 322, 342, 352, 372, and 382. That logic enables each of Applicants' controllers to function as a master controller, or as a target controller, or as both a master controller and a target controller.

By “master controller,” Applicants mean a data storage and retrieval system controller that receives one or more commands from one or more host computers and then issues one or more master controller commands to the other data storage and retrieval system controllers. By “target controller,” Applicants mean a data storage and retrieval system controller that receives commands from either a host computer or a master controller, but does not issue commands to other target data storage and retrieval system controllers.

Each controller further includes a computer useable medium, such as computer useable media 314, 324, 344, 354, 374, and 384, having computer readable program code disposed therein to coordinate multiple information storage and retrieval systems as a master controller, or as a target controller, or as both a master controller and a target controller. In certain embodiments, each controller further includes one or more computer program products, such as computer program products 316, 326, 346, 356, 376, and 386, usable with a programmable computer processor having computer readable program code embodied therein method to coordinate multiple information storage and retrieval systems as a master controller, or as a target controller, or as both a master controller and a target controller.

In the illustrated embodiment of FIG. 3, communication link 395 interconnects controllers 310, 320, 340, 350, 370, and 380. In certain embodiments, communication link 395 is selected from a serial interconnection, such as RS-232 or RS-422, an ethernet interconnection, a SCSI interconnection, a Fibre Channel interconnection, an ESCON interconnection, a FICON interconnection, a Local Area Network (LAN), a private Wide Area Network (WAN), a public wide area network, Storage Area Network (SAN), Transmission Control Protocol/Internet Protocol (TCP/IP), the Internet, and combinations thereof.

Controller 310 is interconnected with communication link 395 via communication links 315 and 318, bridge 304, and I/O adapter 303. Controller 320 is interconnected with communication link 395 via communication links 315 and 328, bridge 304, and I/O adapter 303. Controller 340 is interconnected with communication link 395 via communication links 345 and 348, bridge 334, and I/O adapter 333. Controller 350 is interconnected with communication link 395 via communications link 345 and 358, bridge 334, and I/O adapter 333. Controller 370 is interconnected with communication link 395 via communication links 375 and 378, bridge 364, and I/O adapter 363. Controller 380 is interconnected with communication link 395 via communications link 375 and 388, bridge 364, and I/O adapter 363. In certain embodiments, communication links 315, 318, 328, 345, 348, 358, 375, 378, and 388, are selected from a serial interconnection, such as an RS-232 or an RS-422, an ethernet interconnection, a SCSI interconnection, a Fibre Channel interconnection, an ESCON interconnection, a FICON interconnection, and combinations thereof.

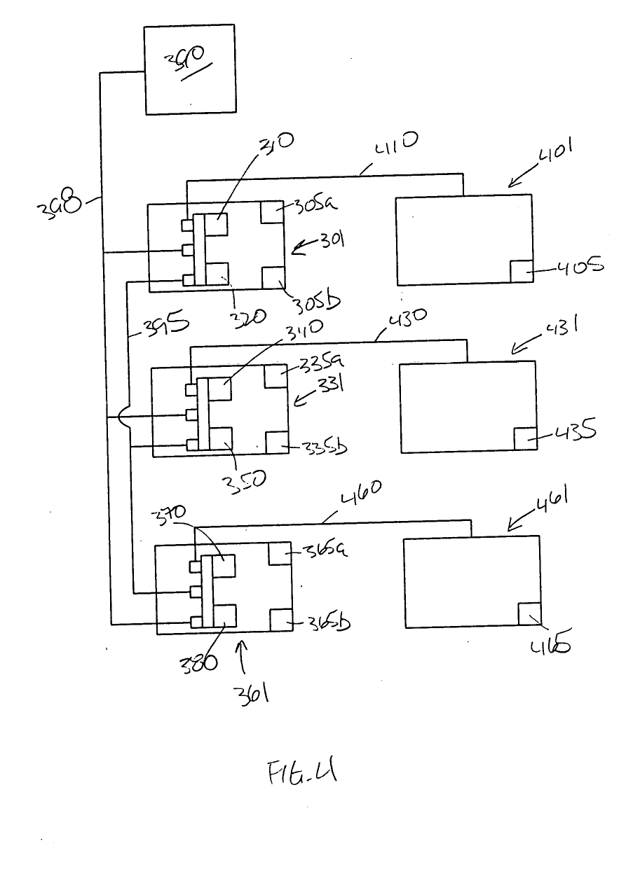

Referring again to FIG. 2, in step 210 each of the plurality of controllers performs peer to peer remote copy (“PPRC”) operations independently of the other interconnected storage system controllers. Referring now to FIGS. 2 and 4, information storage and retrieval system 301 is interconnected with remote storage location 401 via communication link 410. Information storage and retrieval system 331 is interconnected with remote storage location 431 via communication link 430. Information storage and retrieval system 361 is interconnected with remote storage location 461 via communication link 460. In certain embodiments, communication links 410, 430, and 460, are each selected from a serial interconnection, such as RS-232 or RS-422, an ethernet interconnection, a SCSI interconnection, a Fibre Channel interconnection, an ESCON interconnection, a FICON interconnection, a Local Area Network (LAN), a private Wide Area Network (WAN), a public wide area network, Storage Area Network (SAN), Transmission Control Protocol/Internet Protocol (TCP/IP), the Internet, and combinations thereof.

A host computer, such as host 390 (FIGS. 3, 4), provides information and a write command to a primary storage location, such as subsystem 301a (FIG. 3) disposed in data storage and retrieval system 301 (FIGS. 3, 4). Using one or more algorithms disposed in logic 312 (FIG. 3), controller 310 provides the information from a first information storage medium 305a to a second information storage medium 405 disposed in remote storage location 401. In certain embodiments, information storage medium 305a comprises a data cache. In certain embodiments, information storage medium 305a comprises a DASD. In certain embodiments, information storage medium 405 comprises a data cache. In certain embodiments, information storage medium 405 comprises a DASD. Similarly, controllers 320, 340, 350, 370, and 380, independently perform PPRC operations as instructed from one or more host computers.

In step 220, Applicants' method designates one of the plurality of controllers as a master controller. For example, in the illustrated embodiments of FIGS. 3 and 4, Applicants' method in step 220 selects one of controllers 310, 320, 340, 350, 370, or 380, as a master controller. In certain embodiments, step 220 is performed by a host computer, such as host computer 390 (FIGS. 3, 4). In certain embodiments, step 220 is performed by an application running on a host computer, such as application 392 (FIG. 3). In certain embodiments, step 220 is performed by a controller disposed in the host computer, such as controller 396.

In step 230, Applicants' method provides a host command policy to the master controller selected in step 220. In certain embodiments, step 230 is performed by a host computer, such as host computer 390 (FIGS. 3, 4). In certain embodiments, step 230 is performed by an application running on a host computer, such as application 392 (FIG. 3). In certain embodiments, step 230 is performed by a controller disposed in the host computer, such as controller 396.

In step 240, Applicants' method at a first time provides one or more first master controller commands to each target controller, i.e. each controller not designated as the master controller. In certain embodiments, the one or more first master controller commands include initial setup and configuration commands, including a designation of the master controller and the target controllers. In certain embodiments, the master controller simultaneously provides the one or more first master controller commands to each target controller.

In other embodiments, in step 240 the master controller provides the one or more first master controller commands to a first target controller, and that first target controller relays those one or more first master controller commands to a second target controller. In these embodiments, the one or more first master controller commands of step 240 are provided sequentially to each of the target controllers.

For example and referring to FIGS. 3 and 4, if Applicants' method designates controller 310 as the master controller in step 220, then in step 240 controller 310 provides a first set of master controller commands to controllers 320, 340, 350, 370, and 380. In this example using the illustrated embodiments of FIGS. 3 and 4, the one or more first master controller commands of step 240 indicate that controller 310 is designated the master controller and that controllers 320, 340, 350, 370, and 380, are designated target controllers.

Using Applicants' apparatus and method, there is no single point of failure regarding the designation of, and performance by, the master controller. For example in certain embodiments, the designated master controller is disposed in a first information storage and retrieval system. Another controller is disposed in that first information storage and retrieval system, or in another information storage and retrieval system. In the event the master controller becomes non-operational, the other controller performs the functions of the master controller.

In certain embodiments, that other controller monitors the operation of the master controller, determines if the master controller is operational, and in the event the master controller is not operational designates itself as the master controller. In certain embodiments, the other controller is one of the designated target controllers. In other embodiments, the other controller is not one of the designated target controllers.

For example, if designated master controller, namely controller 310, is disposed in system 301. System 301 includes two subsystems, namely subsystems 301a and 301b. Master controller 310 is disposed in subsystems 301a. Target controller 320 is disposed on subsystems 301b. Target controller 320 continuously monitors the operation of master controller 310. In certain embodiments, at regular intervals target controller 320 sends a “heart beat” signal to master controller 310. Upon receiving that heart beat signal, master controller 310 sends a responding heart beat signal to target controller 310.

If target controller 320 receives a responding heart beat signal from master controller 310, then target controller 320 determines that master controller 310 is operational. Alternatively, if target controller 320 does not receive a responding heart beat signal from master controller 310, then target controller 320 determines that master controller 310 is no longer operational in the event master controller 310 becomes non-operational, target controller 320 immediately designates itself the master controller, and performs the functions of the master controller thereafter.

Neither host 390, nor the remaining target controllers 340, 350, 370, or 380, are notified that controller 320 is now functioning as the master controller. Thus, Applicants' method provides transparent failover protection in the event a designated master controller becomes non-operational.

In step 250, Applicants' method provides at a second time one or more second master controller commands to each of the target controllers. Step 250 is performed by the designated master controller. In certain embodiments, the one or more second master controller commands cause each of the target controllers to adjust the flow of data into and/or from the one or more information storage and retrieval systems. In certain embodiments, the one or more second master controller commands of step 250 include one or more commands that cause each target controller to stop accepting write operations from the one or more host computers. In certain embodiments, the one or more second master controller commands of step 250 include one or more commands that cause each target controller to stop sending data to one or more remote storage locations. In certain embodiments, the one or more second master controller commands of step 250 include one or more commands that cause each target controller to resume sending data to the one or more remote storage locations. In certain embodiments, the one or more second master controller commands of step 250 include one or more commands that cause each target controller to form one or more consistency groups.

Applicants' method transitions from step 250 to step 260 wherein all the controllers, including the master controller, form one or more consistency groups. Thus, in step 260 the master controller issues commands to the target controllers to form one or more consistency groups, and causes itself to form one or more consistency groups. In essence, the master controller is functioning both as a master controller and as a target controller in step 260.

As those skilled in the art will appreciate, volumes in the primary and secondary DASDs are “consistent” when all writes have been transferred in their logical order, i.e., all earlier writes transferred first before their corresponding dependent writes. In a banking example, this means that an earlier-in-time $400 deposit is written to the secondary volume before a later-in-time $300 withdrawal. By “consistency group,” Applicants mean a collection of updates to the primary volumes, i.e. the first information stored in DASDs 305a, 305b, 335a, 335b, 365a, and 365b, such that dependent writes are secured in a consistent manner. In the banking example, this means that the withdrawal transaction is in the same consistency group as the deposit or in a later group; the withdrawal cannot be in an earlier consistency group. Consistency groups maintain data consistency across volumes and storage devices. If a failure occurs, consistency groups ensure that data is recovered from the secondary volumes will be consistent. Formation of consistency groups is described in U.S. Pat. Nos. 6,484,187; 5,615,329; and 5,504,861, which are assigned to IBM and incorporated herein by reference in their entirety.

Applicants' method transitions from step 260 to step 270 wherein each target controller provides status information to the master controller. In certain embodiments, the status information of step 270 comprises a flag which the target controller turns on if one or more consistency groups were formed in step 260. In certain embodiments, the status information of step 270 comprises a byte or a frame which the target controller sets to 1 if one or more consistency groups were formed in step 260.

Applicants' method transitions from step 270 to step 250 and continues.

In certain embodiments, individual steps recited in FIG. 2 may be combined, eliminated, or reordered.

Applicants' invention further includes an article of manufacture comprising a computer useable medium, such as computer useable media 314, (FIG. 3), 324 (FIG. 3), 344 (FIG. 3), 354 (FIG. 3), 374 (FIG. 3), and/or 384 (FIG. 3), having computer readable program code disposed therein to implement Applicants' method to coordinate multiple information storage and retrieval systems. In certain embodiments, the computer useable medium having computer readable program code disposed therein implements one or more steps recited in FIG. 2.

Applicants' invention further includes a computer program product, such as computer program products 316 (FIG. 3), 326 (FIG. 3), 346 (FIG. 3), 356 (FIG. 3), 376 (FIG. 3), and/or 386 (FIG. 3), usable with a programmable computer processor having computer readable program code embodied therein to implement Applicants' method to coordinate multiple information storage and retrieval systems. In certain embodiments, the computer program code implements one or more steps recited in FIG. 2.

While the preferred embodiments of the present invention have been illustrated in detail, it should be apparent that modifications and adaptations to those embodiments may occur to one skilled in the art without departing from the scope of the present invention as set forth in the following claims.

1. A method to coordinate interconnected information storage and retrieval systems, wherein each of the information and storage systems is capable of communicating with one or more host computers, comprising the steps of:
providing one or more interconnected information storage and retrieval systems;
providing a plurality of controllers, wherein one or more of said plurality of controllers is disposed in each of said one or more information storage and retrieval systems;
designating one of said plurality of controllers as a master controller and the remaining controllers as target controllers;
generating one or more master controller commands by said master controller;
providing said one or more master controller commands to each of said target controllers, wherein said one or more master controller commands cause said target controllers to adjust the flow of data into and out of each of said one or more information storage and retrieval systems.

2. The method of claim 1, further comprising the step of providing by said master controller to each of said target controllers one or more master controller commands causing each of said target controllers to stop accepting write operations from said one or more host computers.

3. The method of claim 1, further comprising the step of providing by said master controller to each of said target controllers one or more master controller commands causing each of said target controllers to form one or more consistency groups.

4. The method of claim 3, wherein each of said information storage and retrieval systems is capable of providing information to one or more remote storage locations, further comprising the step of providing by said master controller to each of said target controllers one or more master controller commands causing each of said target controllers to stop providing data to said one or more remote storage locations.

5. The method of claim 1, further comprising the steps of:
providing a host computer policy command to said master controller; and
providing at a first time by said master controller to each target controller one or more first master controller commands; and
providing at a second time by said master controller to each target controller one or more second master controller commands.

6. The method of claim 1, further comprising the step of providing status information to said master controller by each target controller.

7. An article of manufacture comprising a computer useable medium having computer readable program code disposed therein to coordinate controllers disposed in one or more interconnected information storage and retrieval systems, wherein each of the multiple information and storage systems is capable of communicating with one or more host computers, the computer readable program code comprising a series of computer readable program steps to effect:
receiving a designation as a master controller and a designation that the remaining controllers comprise target controllers;
generating one or more master controller commands;
providing said one or more master controller commands to each of said target controllers, wherein said one or more master controller commands cause said target controllers to adjust the flow of data into and out of each of said one or more information storage and retrieval systems.

8. The article of manufacture of claim 7, said computer readable program code further comprising a series of computer readable program steps to effect providing to each of said target controllers one or more master controller commands causing each of said target controllers to stop accepting write operations from said one or more host computers.

9. The article of manufacture of claim 7, the computer readable program code comprising a series of computer readable program steps to effect providing to each of said target controllers one or more master controller commands causing each of said target controllers to form one or more consistency groups.

10. The article of manufacture of claim 7, wherein each information storage and retrieval system is capable of providing data to one or more remote storage locations, the computer readable program code comprising a series of computer readable program steps to effect providing to each of said target controllers one or more master controller commands causing each of said target controllers to stop providing data to said one or more remote storage locations.

11. The article of manufacture of claim 7, said computer readable program code further comprising a series of computer readable program steps to effect:
receiving a host computer policy command;
providing at a first time to each target controller one or more first master controller commands; and
providing at a second time to each target controller one or more second master controller commands.

12. The article of manufacture of claim 7, said computer readable program code further comprising a series of computer readable program steps to effect receiving status information from each target controller.

13. A computer program product usable with a programmable computer processor having computer readable program code embodied therein to coordinate a plurality of controllers disposed in one or more interconnected information storage and retrieval systems, wherein each of the multiple information and storage systems is capable of communicating with one or more host computers, comprising:
computer readable program code which causes said programmable computer to receive a designation as a master controller and a designation that the remaining controllers comprise target controllers;
computer readable program code which causes said programmable computer to generate one or more master controller commands;
computer readable program code which causes said programmable computer to provide said one or more master controller commands to each of said target controllers, wherein said one or more master controller commands cause said target controllers to adjust the flow of data into and out of each of said one or more information storage and retrieval systems.

14. The computer program product of claim 13, further comprising computer readable program code which causes said programmable computer to provide to each of said target controllers one or more master controller commands causing each of said target controllers to stop accepting write operations from said one or more host computers.

15. The computer program product of claim 13, further comprising computer readable program code which causes said programmable computer to provide to each of said target controllers one or more master controller commands causing each of said target controllers to form one or more consistency groups.

16. The computer program product of claim 13, wherein each of said information storage and retrieval systems is capable of sending information to one or more remote storage locations, further comprising computer readable program code which causes said programmable computer to provide to each of said target controllers one or more master controller commands causing each of said target controllers to stop sending data to said one or more remote storage locations.

17. The computer program product of claim 13, further comprising:
computer readable program code which causes said programmable computer to receive a designation as a master controller;
computer readable program code which causes said programmable computer to receive a host computer policy command;
computer readable program code which causes said programmable computer to provide at a first time to each of the target controllers one or more first master controller commands; and
computer readable program code which causes said programmable computer to provide at a second time to each of the target controllers one or more second master controller commands.

18. The computer program product of claim 13, further comprising computer readable program code which causes said programmable computer to receive status information from each of said target controllers.

19. A controller disposed in a first data storage and retrieval system, wherein said controller is capable of communicating with other interconnected data storage and retrieval system controllers, comprising:
one or more master controller commands to form one or more consistency groups;
logic to communicate said one or more master controller commands to a second controller disposed in a second data storage and retrieval system; and
logic to receive status information regarding said one or more consistency groups from said second controller.

20. A data storage and retrieval system comprising a controller, wherein said controller comprises:
one or more master controller commands to form one or more consistency groups;
logic to communicate said one or more master controller commands to a second controller disposed in a second data storage and retrieval system; and
logic to receive status information regarding said one or more consistency groups from said second controller.
